(19) United States
(12) Patent Application Publication
(10) Pub. No.: US 2026/0286149 A1
(43) Pub. Date: Sep. 24, 2026

(54) WATER-BASED COATING COMPOSITION

(71) Applicants: THE CHEMOURS COMPANY FC, LLC, WILMINGTON, DE (US); CHEMOURS-MITSUI FLUOROPRODUCTS CO., LTD., TOKYO (JP)

(72) Inventor: MASAMICHI SATO, SHIZUOKA-SHI (JP)

(73) Assignees: THE CHEMOURS COMPANY FC, LLC, WILMINGTON, DE (US); CHEMOURS-MITSUI FLUOROPRODUCTS CO., LTD., TOKYO (JP)

(21) Appl. No.: 19/474,377

(22) PCT Filed: Apr. 10, 2024
(86) PCT No.: PCT/US2024/023785

§ 371 Date: Oct. 10, 2025

(30) Foreign Application Priority Data
Apr. 11, 2023 (JP) 2023-064040

(51) Int. Cl. C09D 7/61; C08K 3/34; C08K 5/00; C09D 7/40; C09D 7/63; C09D 163/00

(52) U.S. Cl. CPC C09D 7/61; C09D 7/63; C09D 7/68; C09D 7/69; C09D 163/00; C08K 3/34; C08K 5/0091; C08K 2201/005

(57) ABSTRACT

To provide a water-based coating capable of forming a coating film with excellent corrosion resistance and thermal conductivity, as well as a coating film and an article. A water-based coating composition, in which silicon carbide (SiC) particles and epoxy resin particles are dispersed in a water-based medium, wherein the ratio of the silicon carbide (SiC) excluding the water-based medium is 40 to 65% by mass.

### CROSS REFERENCE TO RELATED APPLICATIONS

This application claims the benefit of priority of Japanese Patent Application No. 2023-064040 filed Apr. 11, 2023, the disclosures of which are incorporated herein by reference in its entirety.

The present invention relates to a water-based coating capable of forming a coating film with excellent corrosion resistance and thermal conductivity, and to a coating film and article obtained by using the coating. In detail, the present invention relates to a water-based coating composition in which silicon carbide (SiC) particles and epoxy resin particles are dispersed in a water-based medium.

### Conventional Technology

Power semiconductors that control electric power have been attracting attention in recent years, especially for use in electric vehicles (EVs) and plug-in hybrid electric vehicles (PHEVs). Power semiconductors generate a lot of heat because they use high current and high voltage, so efficient discharge of heat during use is important.

To date, air cooling or liquid cooling via heat sinks such as a heat dissipation plate or heat dissipation fins has been primarily used for heat dissipation when using power semiconductors, but in order to simplify the heat dissipation mechanism and obtain excellent heat dissipation performance, immersion cooling, in which power semiconductor devices are cooled by directly immersing in circulating liquid media, which is advantageous in terms of space, has attracted attention.

However, if power semiconductor devices are immersed in the liquid medium as they are, the metal parts of the power semiconductor devices will corrode.

Therefore, there is a need for coatings that can form a coating film with excellent corrosion resistance and thermal conductivity that can be suitably used for immersion cooling of power semiconductors.

For example, Patent Document 1 discloses a coating composition capable of forming a coating film with high heat dissipation effect for use on a metal plate used as a heat sink. This heat dissipation coating composition contains a binder resin and orthorhombic silicate mineral filler, and is said to have a high heat dissipation effect when the average particle diameter of the filler is controlled.

Technology for including particles with a particle diameter of 10 μm or larger in the coating film to form unevenness with large height differences on the surface of the coating film is known, resulting in a coating film with more efficient heat dissipation by radiation and convection (Patent Document 2). On the other hand, the heat dissipation effect or the amount of heat released from the coating film surface depends on the thickness of the coating film where forming a thin coating film increases the thermal energy transport effect and adding a specific acrylic resin or the like has been proposed to ensure bonding with the substrate and to provide mechanical strength in addition to favorable heat dissipation characteristics of the coating film (Patent Document 3).

Furthermore, a heat dissipation material for semiconductor devices containing a specific epoxy resin and curing agent, a heat-conductive filler, and an organic titanate has also been proposed (Patent Document 4).

Although the aforementioned conventional technology discloses coating compositions (materials) with high heat dissipation, none of them are designed with immersion cooling in mind and are not sufficient in terms of corrosion resistance. In addition, in recent years, from the viewpoints of environmental protection and volatile solvent recovery costs, water-based coatings are required instead of solvent-based coatings that use organic solvents as the medium.

### PRIOR ART DOCUMENTS

### Patent Documents

Patent Document 1: Japanese Unexamined Patent Application Publication 2013-100454
Patent Document 2: International Patent Publication WO 2009/142036
Patent Document 3: Japanese Unexamined Patent Application Publication 2013-209645
Patent Document 4: Japanese Unexamined Patent Application Publication 2000-183252

### SUMMARY OF THE INVENTION

### Problem to be Solved by the Invention

An object of the present invention is to provide a water-based coating that can form a coating film with excellent corrosion resistance and thermal conductivity suitable for immersion cooling of power semiconductors, as well as a coating film and an article.

### Means for Solving the Problem

As a result of diligent study to solve the problems described above, the present inventors found that a coating film with excellent corrosion resistance and thermal conductivity can be formed by dispersing silicon carbide (SiC) particles and epoxy resin particles in a water-based medium, and thus achieved the present invention.

In other words, the above issues can be solved by the present invention as described below.
(1) A water-based coating composition, in which silicon carbide (SiC) particles and epoxy resin particles are dispersed in a water-based medium, wherein
the ratio of the silicon carbide (SiC) excluding the water-based medium is 40 to 65% by mass.
(2) The water-based coating composition according to (1), wherein the average particle diameter of the silicon carbide (SiC) particles is in the range of 0.3 to 5.0 μm.
(3) The water-based coating composition according to (1) or (2), further including organic titanate.
(4) The water-based coating composition according to any one of (1) to (3), wherein the epoxy resin is a linear high molecular weight epoxy compound.
(5) A coating film formed by coating the water-based coating composition according to any one of (1) to (4).
(6) An article having a coating film according to (5).
(7) An electronic component including the article according to (6).

### Effect of the Invention

The present invention provides a water-based coating composition capable of forming a coating film with excellent corrosion resistance and thermal conductivity suitable for immersion cooling of power semiconductors, a coating film formed by coating with the composition, articles having such a coating film, and electronic components including such articles.

In addition, the water-based coating compositions can be deposited at temperatures below 200° C., so use in power semiconductor devices containing materials such as resin molds and solder that cannot withstand temperatures above 200° C. is possible.

Furthermore, the compositions use a water-based medium, and therefore are superior to solvent-based coatings that use organic solvents as the medium, from the perspective of the environment.

### BRIEF DESCRIPTION OF THE DRAWINGS

FIG. 1 depicts a thermal conductivity measurement device.

### MODE FOR CARRYING OUT THE INVENTION

The present invention will be described in detail hereinafter.

### 1. Coating Composition

The water-based coating composition of the present invention includes epoxy resin particles, silicon carbide (SIC) particles, and organic titanates.

### Epoxy Resin Particle

The “epoxy resin” used in the present invention is a compound having two or more epoxy groups in a molecule and is a thermoset resin that can be cross-linked by a curing agent having one of the following structures: amino group, thiol group, hydroxy group, phenol group, imidazole group, dicyandiamide, acid anhydride, or hydrazide. Alternatively, the epoxy resin may be a thermoplastic phenoxy resin with epoxy groups at both ends of the molecule ring-opened after polymerizing the epoxy resin to a high molecular weight in a linear form. Furthermore, by polymerizing other monomers to the epoxy groups at both ends of the molecule of an epoxy resin that has been polymerized to a high molecular weight as described above, a copolymer, terpolymer, or other modified epoxy resin may be produced, in which one molecule is composed of two or more kinds of repeating units.

An example of an epoxy resin suitable for a corrosion-resistant coating application is an epoxy resin produced through polymerization of bisphenol A and epichlorohydrin, but a linear high molecular weight epoxy compound with a molecular weight of 10,000 or more is particularly preferable. The high molecular weight enables the formation of a coating film with superior corrosion resistance without the use of a hardener, although heating is required for film formation after coating. On the other hand, thermal curing with a curing agent is required to form a film of relatively low molecular weight epoxy resin, and the curing agent component in the coating film may contribute to a decrease in corrosion resistance.

Water-soluble epoxy resins are undesirable because they reduce the water resistance of the coating film. However, a modified epoxy resin, in which a second component with high water affinity is polymerized from the end of the epoxy resin, does not require a surfactant for dispersion of the resin particles, and thus the surfactant component remaining in the coating film can be reduced, improving the corrosion resistance of the coating film and making them suitable for use. The second component described above should be adjusted to an amount that does not cause deterioration of the coating film corrosion resistance.

The epoxy resin particles of the present invention may be prepared by dispersing the particle powder in a water-based medium, but from the standpoint of productivity, use of a pre-prepared water-based dispersion of epoxy resin particles is preferable.

The average particle diameter of the epoxy resin particles is preferably 0.05 to 0.5 μm.

The shape of epoxy resin particles is not particularly limited but are preferably spherical in shape for dispersion stability.

Examples of specific products of epoxy resin particles include: EPICLON® H-502-42W, EPICLON H-504-42W, EPICLON H-505-42W, EPICLON EXA-8843, EPICLON EM-N01-56W, (2K epoxy), EPICLON EM-102-60W, (2K epoxy) (all manufactured by DIC Corporation); jER® series W2801, W2821R70, W3435R67, W8735R70, W1155R55 (all 2K epoxy, manufactured by Mitsubishi Chemical Co.); ADEKA RESIN® EM series EM-0427WC, EM-0425C, EM-101-50, EM-051R, EM-0517, EM-058 (2K epoxy, manufactured by ADEKA Corporation), EM-0464, EM-0180, EM-0434AN (1K epoxy, manufactured by ADEKA Corporation); and the like.

### Silicon Carbide Particles

The silicon carbide (SiC) particles are spherical or anisotropic silicon carbide particles, preferably with an average particle diameter in the range of 0.3 to 5.0 μm, more preferably 0.5 to 3.0 μm. In addition, the maximum particle size (Dmax) should be less than 15 μm, and more preferably, less than 10 μm.

If the particle size of silicon carbide particles is too large, liquid may easily penetrate through the surface of the coating film, resulting in reduced corrosion resistance. In addition, if the particle size of silicon carbide particles is too small, the particles will be difficult to disperse in the coating which can easily lead to defects and reduced thermal conductivity in the coating film.

In the present invention, the average particle diameter is determined as the particle diameter (d50) at 50% cumulative value (volume basis). The maximum particle size is the maximum particle size on a volume basis. Various known measurement methods such as laser diffraction, centrifugal sedimentation, and electrical resistivity can be used.

In the present invention, the percentage of silicon carbide (SIC) should be 40 to 65% by mass. A high percentage of silicon carbide will cause the coating film to peel easily, while a percentage of 70 mass percent or more will cause corrosion resistance problems.

The shape of the silicon carbide particles is preferably anisotropic particles with an aspect ratio of 0.5 to 0.9. The aspect ratio is a value expressed as b/a, where a is the major diameter (major axis diameter) of the particle in a triaxial system and b is the minor diameter (minor axis diameter).

For silicon carbide particles, for example, the GC series manufactured by Fujimi Incorporated, and the C series manufactured by Fujimi Incorporated can be used.

### Other Fillers

The water-based coating composition of the present invention can contain fillers other than silicon carbide as long as they do not cause deterioration of the performance (corrosion resistance, thermal conductivity) of the resulting coating film. Various organic and inorganic materials can be selected as other fillers in the present invention, depending on the desired properties. Examples of organic substances include engineering plastics such as polyphenylene sulfides, polyether ether ketones, polyether sulfones, polyphenyl sulfones, polyamides, polyimides, phenolic resins, fluororesins, urea resins, urethane resins, melamine resins, polyester resins, polyether resins, acrylic resins, acrylic silicone resins, silicone resins, silicone polyester resins, and the like as well as general purpose plastics. Examples of inorganic substances include metals, metal oxides (aluminum oxide, zinc oxide, tin oxide, titanium oxide, and the like), glass, ceramics, silicon oxide, calcium fluorides, carbon black, graphite, mica, barium sulfate, and the like.

Various shapes of filler materials can be used in the water-based coating compositions of the present invention, including particulate, fibrous, and squamous (flake) shaped substances.

In the water-based coating compositions of the present invention, the average particle diameter of the filler can be selected according to the substance, shape, and required properties.

### Organic Titanate

The coating composition of the present invention and coating film that uses this coating composition preferably contains organic titanate. Organic titanates are thought to improve the dispersion of silicon carbide particles and act as crosslinking agents for epoxy resins. Organic titanates are soluble in water and are not limited, so long as they are stable in water to some extent to ensure the stability of the coating composition until applied and are preferably alkoxy titanium, titanium acylate, or titanium chelate provided with a structure containing a Ti—O—C bond formed by Ti(IV) or Ti(III) and a compound having an alcoholic hydroxyl group, phenolic hydroxyl group, or carboxyl group. Of these, titanium aminoethylaminoethanolate or similar compounds are particularly preferred. Those with one hydrolysis group (an alkoxy group of low carbon number (specifically, an isopropoxy group, ethoxy group, or the like)) in the molecule are preferably used because it is thought that the adverse effects of the release of the hydrolysis group can be suppressed.

### Other Components (Additives)

The water-based coating composition of the present invention may also contain various additives used in ordinary coatings in accordance with the required properties such as dispersibility, conductivity, foaming prevention, enhanced wear resistance, and the like, examples of which include: surfactants (for example, polyoxyethylene alkyl ether or polyoxyethylene alkyl phenyl ether-based nonionic surfactants such as Leocol manufactured by Lion, Inc., the TRITON and TERGITOL series manufactured by the Dow Chemical Company, and Emulgen manufactured by KAO, Inc.; sulfocuccinate-based, alkyl ether sulfonic acid sodium salt-based, or sulfate mono-long-chain alkyl-based anionic surfactants such as Lipal manufactured by Lion, Inc. and Emal and Pelex manufactured by KAO, Inc.; polycarboxylate or acrylate-based polymer surfactants such as Leoarl manufactured by Lion, Inc. or OROTAN manufactured by the Dow Chemical Company; L-77 manufactured by Momentive, and the Surfynol Series manufactured by AirProduct (Surfynol SE-F, Surfynol 420, Surfynol 440, Surfynol 465, Surfynol 485, and the like)); film forming agents (for example, polymeric film forming agents such as polyamides, polyamide-imides, acrylics, and acetates; higher alcohols or ethers; and polymeric surfactants having a film-forming effect); and thickeners (for example, water-soluble celluloses, solvent dispersion thickeners, sodium alginates, caseins, sodium caseinates, xanthan gums, cellulose nanofibers, polyacrylic acids, and acrylic esters), and the like.

### Water-Based Medium

The water-based coating composition of the present invention contains water as a main medium. However, although not preferable from the perspective of the environment or costs, a polar solvent that is compatible with water can be added or an organic solvent that is incompatible with water can be dispersed to adjust rheological properties such as liquid viscosity of the water-based coating composition and to improve dispersion of silicon carbide (SiC) particles, organic titanates, and other fillers. In addition, by adding a polar solvent, the epoxy resin before curing is dissolved and the epoxy resin becomes more uniform in the drying process after coating. As a result of the increased density of the coating film or the fact that the epoxy resin becomes more likely to penetrate the indented portions of the recesses and protrusions of the substrate, an effect of enhancing the adhesive force with the substrate can be expected.

Examples of polar solvents include: alcohols, N-methyl-2-pyrrolidone (NMP), N-ethylmoropholine, N-formylmorpholine, N-acetylmorpholine, N,N′-dimethylethylene urea, N,N-dimethylacetamide or N, N-dimethylformamide, γ-butyrolactone, and the like.

### 2. Coating Film

The “coating film” of the present invention is a coating film obtained by coating the water-based coating composition of the present invention. The water-based coating composition of the present invention exhibits excellent thermal conductivity and corrosion resistance. The “coating film” of the present invention includes a one-coat coating, a primer layer of the water-based coating composition of the present invention that adheres to a substrate, and a plurality of layers coated and laminated on top of the primer layer.

The “coating film” of the present invention can be formed by various typically used coating methods such as spray coating, dip coating, spin coating, and the like, for example, and the coating film after coating is preferably heated to at least the melting point of the resin in order to achieve melt-fluidity and obtain a uniform coating film.

For efficient heat removal in immersion cooling, a thermal conductivity of 0.3 W/m-K or higher is preferred, 0.4 W/m-K or higher is more preferred, and 0.5 W/m-K or higher is especially preferred.

### 3. Coated Article

The “coated article” of the present invention is an article having a coating film obtained by applying the water-based coating composition of the present invention.

The “coated articles” include automotive parts such as power semiconductors, and the like, and heat exchangers and the like, which are not limited to automotive applications.

### EXAMPLES

The following examples describe the preparation and performance evaluation of the water-based coating composition of the present invention, but the invention is not limited in any way to these examples.

The following reagents were used in the examples and comparative examples.

### Epoxy Resin

EPICLON H-502-42W (aqueous dispersion liquid of modified polymeric epoxy resin particles) manufactured by DIC Corporation, solid content 39.2% by mass.

### Silicon Carbide (SiC)

### Manufactured by Fujimi Incorporated

GC #3000, average particle diameter (D50) 4 μm; maximum particle size 13 μm
GC #6000, average particle diameter (D50) 2 μm; maximum particle size 8 μm
GC #8000, average particle diameter (D50) 1.2 μm; maximum particle size 6 μm
GC #10000, average particle diameter (D50) 0.5 μm; maximum particle size 2 μm

### Alumina

Spherical alumina DAM-03 manufactured by DENKA CORPORATION, average particle diameter 4.5 μm
Spherical alumina DAW-01 manufactured by DENKA CORPORATION, average particle diameter 1.8 μm
Spherical alumina ASFP-40 manufactured by DENKA CORPORATION, average particle diameter 0.3 μm
Spherical alumina Aluna beads® CB-P02, average particle diameter 2.9 μm, manufactured by Showa Denko K.K.

### Boron Nitride

Squamous boron nitride UHP-S2, average particle diameter 0.7 μm, manufactured by Showa Denko K.K.

### Organic Titanate

ORGATIX TC-510 manufactured by Matsumoto Fine Chemical Co. Ltd.

### Example 1 (Composition without Organic Titanate)

At room temperature, 17.8 g of pure water was placed in a 150-mL stainless steel container, and 0.5 g of surfynol SE-F as a wetting agent was slowly added dropwise while stirring at 140 rpm using a stirrer (product of Yamato Scientific Co. LTD.). 16.0 g of filler material (silicon carbide (SIC) GC #8000) was added and dispersed by ultrasound for 5 minutes. Next, 61.2 g of epoxy resin particle aqueous dispersion liquid (EPICLON H-502-42W) was added and stirred for 5 minutes. After slowly dripping 1.5 g of surfynol SE-F as an additional wetting agent, 3.0 g of ethylene glycol was added as a film-forming agent, and the water-based coating composition was stirred for 10 minutes.

### Example 9 (Composition Including Organic Titanate)

At room temperature, 34.7 g of pure water was placed in a 150-mL stainless steel container, and 0.5 g of surfynol SE-F as a wetting agent was slowly added dropwise while stirring at 140 rpm using a stirrer (product of Yamato Scientific Co. LTD.). 24.0 g of filler material (silicon carbide (SIC) GC #10000) was added and dispersed by ultrasound for 5 minutes. Thereafter, 5.7 g of an organic titanium compound (ORGATIX TC-510) was added dropwise with stirring, and the mixture was stirred for 10 minutes. Next, 30.6 g of epoxy resin particle aqueous dispersion liquid (EPICLON H-502-42W) was added and stirred for 5 minutes. After slowly dripping 1.5 g of surfynol SE-F as an additional wetting agent, 3.0 g of ethylene glycol was added as a film-forming agent, and the water-based coating composition was stirred for 10 minutes.

### Examples 2 to 8, 10, 11

The amounts of each component were adjusted to achieve the coating compositions (% by mass) listed in Table 1 below, and the same procedure as in Example 1 or 9 (for example, in Example 10, 35.7 g of epoxy resin particle aqueous dispersion liquid was substituted for the 30.6 g in Example 9, and 2.9 g of organic titanate (ORGATIX TC 510) in place of the 5.7 g) was used to obtain a water-based coating composition.

### Comparative Examples 1 to 9

Coating compositions were obtained using the same procedure as in Example 1 while adjusting the amount of each component so as to obtain the coating compositions (mass %) shown in Comparative Examples 1 to 9 of Table 1.

Note that alumina (73.1% by mass) and boron nitride (42.7% by mass) are almost the same as silicon carbide (60% by mass) by volume.

A coating film for use in performance evaluation was produced using the following procedure.

### Preparation of Test Sample for Corrosion Resistance Evaluation

A 70 mm×50 mm copper sheet (oxygen-free copper C1020-1/2H, thickness 1 mm) was used as the substrate, wiped and degreased with isopropyl alcohol, and then spray-coated (coating composition 0.1 to 0.3 g) with the coating compositions of the respective examples and comparative examples using a spray gun (W-101-101G, manufactured by Anest Iwata Corporation) and baked at 120° C. for 10 minutes, followed by 140° C. (test condition 1) or 180° C. (test condition 2) for 15 minutes to form test samples for evaluation with a film thickness of roughly 10 μm.

Instead of a copper plate, an aluminum alloy plate (ADC12, 2 mm thick) was used to prepare test samples for evaluation in the same way.

### Corrosion Resistance Evaluation Method

The obtained test samples for evaluation (copper plate substrate and aluminum alloy plate substrate) were immersed in boiling 5% brine for 8 hours, then the brine adhering to the surface was rinsed off with pure water and the water was wiped off with a tissue.

The test samples were visually checked for blisters and substrate exposure after immersion.

Furthermore, the corrosion resistance of the coating film was evaluated according to the JIS K5600-5-6 cross-cut method (Cross-cut grid test).

Crosscuts were made using a commercially available cutter in a grid pattern to produce 100 squares of 1 mm cut pieces, and Scotch® filament tape 898 (manufactured by 3M) was applied and pulled off 10 times. The evaluation was made by counting the number of squares that did not peel off after 10 tape peels.

The number of squares that did not peel off after the tape peeling process is shown in Table 1.

### Thermal Conductivity Evaluation Method

The following method was used to measure the thermal conductivity of the water-based coating compositions.

### Preparation of Test Samples for Thermal Conductivity Measurement

A 20 mm×20 mm copper sheet (oxygen-free copper C1020-1/2H, 1 mm thick) was used as the substrate, wiped and degreased with isopropyl alcohol, drop-cast with a dropper with the coating compositions of each example and comparative example, and baked at 120° C. for 10 minutes, followed by 140° C. (test condition 1) or 180° C. (test condition 2) for 15 minutes to obtain thermal conductivity measurement test samples with a film thickness of roughly 50 to 80 μm. The film thickness of the obtained test samples was measured using an eddy current film thickness meter (ISOSCOPE manufactured by Fischer Instruments K. K.).

### Thermal Conductivity Measurement

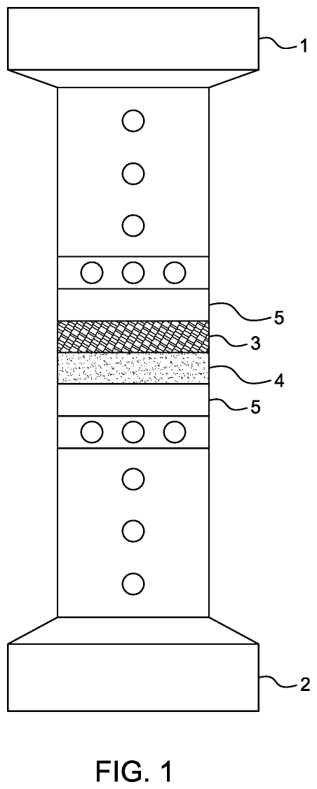

The thermal conductivity of the coating film (W/m-K) was measured using the following method (temperature gradient method), as described in JIS H7903 using a thermal conductivity measuring device (TCM1000 manufactured by RHESCACO., LTD.). First, since it was necessary to adhere the test samples to the thermal conductivity measurement device for accurate measurement, silicone grease (Shin-Etsu Chemical Co., Ltd., oil compound for heat dissipation G-747, thermal conductivity 0.9 W/m-K) was applied to both sides of the test samples while measuring the weight so that the thickness was 15 μm on each side. Next, a test sample coated with silicone grease was set in the thermal conductivity measurement device and measured (see FIG. 1; in FIG. 1, the hole indicates the thermometer insertion opening). The thermal resistance obtained from the measurement and the thermal conductivity of the coating film to be determined are expressed by the following equation.

$$[ Thermal resistance obtained by measurement ] = 2 \times ( thickness of silicone grease / thermal conductivity of silicone grease ) + ( thickness of copper substrate / thermal conductivity of copper substrate ) + ( thickness of coating film / thermal conductivity of coating film )$$

Here, the thermal resistance on the left-hand side is obtained from the above measurement, and on the right-hand side, the thermal conductivity of the coating film can be calculated since values other than the thermal conductivity of the coating film to be determined are known. The calculated thermal conductivity of the coating film is shown in Table 1.

TABLE 1

| | Composition | | | | | % by mass | | | | | |
|---|---|---|---|---|---|---|---|---|---|---|---|
| | | Silicon carbide | | | | Other Fillers | | | | | Organic |
| | Resin | GC# | GC# | GC# | | | | | | BN | Titanate |
| | Epoxy | 3000 | 6000 | 8000 | GC#10000 | DAM-03 | DAW-01 | ASFP-40 | CB-P02 | (UHP-S2) | (TC-510) |
| Example 1 | 60 | | | 40 | | | | | | | |
| Example 2 | 60 | | 40 | | | | | | | | |
| Example 3 | 60 | | | | 40 | | | | | | |
| Example 4 | 50 | | | | 50 | | | | | | |
| Example 5 | 50 | | 50 | | | | | | | | |
| Example 6 | 40 | | 60 | | | | | | | | |
| Example 7 | 40 | | | | 60 | | | | | | |
| Example 8 | 30 | | 60 | | | | | | | | 10 |
| Example 9 | 30 | | | | 60 | | | | | | 10 |
| Example 10 | 35 | | | | 60 | | | | | | 5 |
| Example 11 | 30 | 60 | | | | | | | | | 10 |
| Comparative | 30 | | | | 70 | | | | | | |
| Example 1 | | | | | | | | | | | |
| Comparative | 20 | | 70 | | | | | | | | 10 |
| Example 2 | | | | | | | | | | | |
| Comparative | 20.2 | | | | | 73.1 | | | | | 6.7 |
| Example 3 | | | | | | | | | | | |
| Comparative | 20.2 | | | | | | 73.1 | | | | 6.7 |
| Example 4 | | | | | | | | | | | |
| Comparative | 20.2 | | | | | | | 73.1 | | | 6.7 |
| Example 5 | | | | | | | | | | | |
| Comparative | 20.2 | | | | | | | | 73.1 | | 6.7 |
| Example 6 | | | | | | | | | | | |
| Comparative | 100 | | | | | | | | | | |
| Example 7 | | | | | | | | | | | |
| Comparative | 42.7 | | | | | | | | | 43.1 | 14.2 |
| Example 8 | | | | | | | | | | | |
| Comparative | 30 | | | | | | 60 | | | | 10 |
| Example 9 | | | | | | | | | | | |

| Performance Evaluation | | |
|---|---|---|
| | Corrosion resistance | Thermal conductivity |

| | Processing | | Cross-cut | Thermal conductivity |
|---|---|---|---|---|
| | conditions | Blister | grid test | (W/m · K) |
| Example 1 | 140° C. | No | 100/100 | 0.48 |
| Example 2 | 140° C. | No | 100/100 | 0.41 |
| Example 3 | 140° C. | No | 100/100 | 0.41 |
| Example 4 | 140° C. | No | 100/100 | 0.43 |
| Example 5 | 140° C. | No | 100/100 | 0.46 |
| Example 6 | 140° C. | No | 100/100 | 0.43 |
| Example 7 | 140° C. | No | 100/100 | 0.56 |
| Example 8 | 180° C. | No | 100/100 | 0.52 |
| Example 9 | 180° C. | No | 100/100 | 0.70 |
| Example 10 | 180° C. | No | 100/100 | 0.68 |
| Example 11 | 180° C. | No | 100/100 | 0.58 |
| Comparative | 140° C. | No | 0/100 | — |
| Example 1 | | | | |
| Comparative | 180° C. | No | 0/100 | 0.84 |
| Example 2 | | | | |
| Comparative | 180° C. | Yes | 0/100 | — |
| Example 3 | | | | |
| Comparative | 180° C. | Yes | 0/100 | — |
| Example 4 | | | | |
| Comparative | 180° C. | No | 0/100 | — |
| Example 5 | | | | |
| Comparative | 180° C. | Yes | 0/100 | — |
| Example 6 | | | | |
| Comparative | 140° C. | Yes | 100/100 | 0.17 |
| Example 7 | | | | |
| Comparative | 180° C. | No | 0/100 | — |
| Example 8 | | | | |
| Comparative | 180° C. | Yes | 0/100 | — |
| Example 9 | | | | |

It was confirmed that the water-based coating compositions of the present invention exhibit excellent corrosion resistance and thermal conductivity. Examples 1-11 indicate that the water-based coating compositions of the present invention have good corrosion resistance and thermal conductivity.

The coating composition of Comparative Example 2 also showed that a higher percentage of silicon carbide in the composition components increases thermal conductivity, but also causes corrosion resistance problems.

The water-based coating compositions of the present invention can be used as excellent water-based coatings because they can form a coating film with both good corrosion resistance and thermal conductivity.

### DESCRIPTION OF SYMBOLS

1. Heating part
2. Cooling part
3. Coating film
4. Copper substrate
5. Silicone grease

1. A water-based coating composition, in which silicon carbide (SiC) particles and epoxy resin particles are dispersed in a water-based medium, wherein
the ratio of the silicon carbide (SiC) excluding the water-based medium is 40 to 65% by mass.

2. The water-based coating composition according to claim 1, wherein the average particle diameter of the silicon carbide (SiC) particles is in the range of 0.3 to 5.0 μm.

3. The water-based coating composition according to claim 1, further comprising organic titanate.

4. The water-based coating composition according to claim 3, wherein the epoxy resin is a linear high molecular weight epoxy compound.

5. A coating film formed by coating the water-based coating composition according to claim 4.

6. An article, comprising the coating film according to claim 5.

7. An electronic component, comprising the article according to claim 6.
